(19) United States
(12) Patent Application Publication
(10) Pub. No.: US 2015/0170182 A1
(43) Pub. Date: Jun. 18, 2015

(54) METHOD AND SYSTEM FOR PRESENTING REWARDS DATA FOR CARD TRANSACTIONS

(71) Applicant: MasterCard International Incorporated, Purchase, NY (US)

(72) Inventors: Kristofer Perez, New York, NY (US); Pedro J. Chavarria, Hampton Bays, NY (US); Michael Zhao, New York, NY (US)

(73) Assignee: MasterCard International Incorporated, Purchase, NY (US)

(21) Appl. No.: 14/106,246

(22) Filed: Dec. 13, 2013

(51) Int. Cl. G06Q 30/02

(52) U.S. Cl. CPC G06Q 30/0226

(57) ABSTRACT

A product identifier and cardholder identifier are received, specifying a product and cardholder. Computer database(s) are accessed to retrieve, based on the cardholder identifier, data pertaining to rewards card(s) owned by the cardholder. Reward parameter(s) are associated with each rewards card. The database(s) is accessed to identify, based on the product identifier, merchant identifiers corresponding to merchants offering the product and corresponding price data. At one or more computer processors, for each rewards card and each merchant, a first amount of rewards is computed, which is an amount of rewards that the cardholder will earn by completing a transaction for the product with said merchant using said rewards card, wherein the rewards amount is computed based on at least the reward parameters associated with said rewards card and the offer price corresponding to said merchant. The first rewards amounts corresponding to respective rewards cards and to respective merchants are displayed.

### FIELD

Aspects of the present disclosure relate in general to the computer-aided use of rewards cards for commerce, and more particularly to efficiently aiding consumers with the intelligent selection of rewards cards and merchants for transactions relating to various products.

### BACKGROUND

Rewards programs have become popular and prevalent in a variety of contexts in the marketplace. Rewards programs, also known by various other names such as incentive programs, loyalty programs, or points programs, are designed to encourage repetitive consumption, buying, or usage behavior. Recently, rewards programs pertaining to payment cards such as credit cards have proliferated. Numerous card issuers offer a variety of card products that enable people to earn and accumulate rewards based on the usage of credit cards. This type of reward program is especially attractive to many people because of the widespread use of payment cards in society.

Card rewards programs exist in various forms. For example, some cards provide cash back with each transaction (typically as a percentage of the amount of the transaction, e.g., 1% cash back), others provide points that can used to acquire various goods or services (e.g., 1 point for every dollar charged to a credit card), and others provide goods or services directly (e.g., a discrete good or service whenever a card is used for a transaction exceeding a fixed amount). Some card rewards programs provide rewards that are dependent on the type of transaction (e.g., 1 point for each dollar charged at any gas station, 2 points for each dollar charged at any supermarket, 3 points for each dollar charged at a particular merchant, etc.).

### SUMMARY

In some embodiments of the present disclosure, a product identifier and a cardholder identifier are received. The product identifier and the cardholder identifier correspond to (specify or identify) a product and a cardholder, respectively. At least one computer database is accessed to retrieve, based on the cardholder identifier, data pertaining to one or more rewards cards owned by the cardholder. One or more reward parameters are associated with each rewards card. The computer database(s) is accessed to identify, based on the product identifier, merchant identifiers corresponding to merchants offering the product and the price at which each of those merchants is offering the product. At one or more computer processors, for each rewards card and for each merchant, a first amount of rewards is computed, which is an amount of rewards that the cardholder will earn (i.e., could possibly earn) if the cardholder completes a transaction for the product with said merchant using said rewards card, wherein the rewards amount is computed based on at least the reward parameters associated with said rewards card and the offer price corresponding to said merchant. The first rewards amounts corresponding to respective rewards cards and to respective merchants are displayed to the cardholder. For example, the respective first rewards amounts corresponding to various merchant-card combinations can be displayed in a matrix format, with merchants listed along rows and cards listed along columns (or vice versa), or in any other convenient format. Any of the foregoing processing tasks can be performed by the one or more computer processors.

In some embodiments, a product identifier and a cardholder identifier are received. The product identifier and the cardholder identifier correspond to (specify or identify) a product and a cardholder, respectively. At least one computer database is accessed to retrieve, based on the cardholder identifier, a profile including data specifying a first set of one or more rewards cards owned by the cardholder. One or more reward parameters are associated with each rewards card in the first set. The computer database(s) is accessed to determine, based on the retrieved profile, reward parameters associated with each rewards card in a second set of one or more rewards cards. The cardholder does not own any of the cards in the second set. The computer database is accessed to identify, based on the product identifier, a plurality of merchant identifiers corresponding to merchants offering the product and the price at which each of those merchants is offering the product. At one or more computer processors, for each rewards card in the second set and for each merchant, an amount of rewards is computed, which is an amount of rewards that the cardholder will earn (i.e., could possibly earn) if the cardholder completes a transaction for the product with said merchant using said rewards card in the second set, wherein the rewards amount is computed based on at least the reward parameters associated with said rewards card in the second set and the offer price corresponding to said merchant. The rewards amounts corresponding to respective rewards cards in the second set and to respective merchants are displayed to the cardholder. For example, the respective rewards amounts corresponding to various merchant-card combinations can be displayed in a matrix format, with merchants listed along rows and cards listed along columns (or vice versa), or in any other convenient format. Any of the foregoing processing tasks can be performed by the one or more computer processors.

In some embodiments, a system comprises one or more computer databases, one or more computer processors operably coupled to access the one or more computer databases, and a non-transitory computer-readable storage medium having instructions stored tangibly thereon. At the computer database(s), first data and multiple profiles are stored. The first data include one or more reward parameters associated with each rewards card in a plurality of rewards cards. The profiles are associated with respective cardholders. The profile associated with each cardholder includes second data specifying one or more of the rewards cards owned by said cardholder. When executed by the processor(s), the instructions stored on the storage medium cause the processor(s) to receive a product identifier and a cardholder identifier corresponding to one of the products and one of the cardholders, respectively. The one or more computer databases are accessed to retrieve, based on the received cardholder identifier, the profile associated with said one cardholder. Based on the received product identifier, a plurality of merchant identifiers are identified, corresponding to respective ones of a plurality of merchants offering said one product and the price at which each merchant is offering said one product. For each rewards card associated with the retrieved profile and for each merchant, a first amount of rewards is computed, which is an amount that the cardholder will earn (i.e., could possibly earn) if the cardholder completes a transaction for the product with said merchant using said rewards card, wherein the first rewards amount is computed based on at least the reward parameters associated with said rewards card and the offer price corresponding to said merchant. The first rewards amount corresponding to each rewards card and to each merchant is displayed.

In some embodiments, a system comprises one or more computer databases, one or more computer processors operably coupled to access the one or more computer databases, and a non-transitory computer-readable storage medium having instructions stored tangibly thereon. At the computer database(s), first data and multiple profiles are stored. The first data include one or more reward parameters associated with each rewards card in a plurality of rewards cards. The profiles are associated with respective ones of a plurality of cardholders. The profile associated with each cardholder includes second data specifying a first set of one or more of the rewards cards owned by said cardholder. When executed by the processor(s), the instructions stored on the storage medium cause the processor(s) to receive a product identifier and a cardholder identifier corresponding to one of the products and one of the cardholders, respectively. The one or more computer databases are accessed to retrieve, based on the received cardholder identifier, the profile associated with said one cardholder. Based on the received product identifier, a plurality of merchant identifiers are identified, corresponding to respective ones of a plurality of merchants offering said one product and the price at which each merchant is offering said one product. For each rewards card associated with the retrieved profile and for each merchant, a first amount of rewards is computed, which is an amount that the cardholder will earn (i.e., could possibly earn) if the cardholder completes a transaction for the product with said merchant using said rewards card, wherein the first rewards amount is computed based on at least the reward parameters associated with said rewards card and the offer price corresponding to said merchant. The first rewards amount corresponding to each rewards card and to each merchant is displayed.

### BRIEF DESCRIPTION OF THE DRAWINGS

The following will be apparent from elements of the figures, which are provided for illustrative purposes and are not necessarily to scale.

FIG. 1 is a flow diagram of a process in accordance with some embodiments of the present disclosure.

FIG. 2 is a depiction of an example screen at which a cardholder enters product information in accordance with some embodiments.

FIGS. 3A-3D are depictions of example screens displaying information regarding merchants and rewards cards to a cardholder in accordance with some embodiments.

FIG. 4 is an architecture diagram of a computer that may be used in some embodiments.

FIG. 5 is a flow diagram of a process in accordance with some embodiments of the present disclosure.

FIG. 6 is a flow diagram of a process in accordance with some embodiments of the present disclosure.

### DETAILED DESCRIPTION

This description of the exemplary embodiments is intended to be read in connection with the accompanying drawings, which are to be considered part of the entire written description.

With the proliferation of rewards cards, consumers often find it difficult to decide which rewards card is appropriate to use for purchasing a particular product. This challenge is exacerbated when the product is available from a number of merchants, and some rewards cards offer varying amounts of rewards if the product is purchased from some of those merchants as opposed to other merchants. Consumers who have numerous rewards cards may end up using one of their rewards cards systematically or predominantly, which may be inefficient from a rewards standpoint. Another challenge is that a cardholder may have several rewards cards but may not know how any of them might impact her with respect to a specific purchase that she is contemplating. A better approach is needed to guide and inform cardholders in their buying and card usage behaviors.

Various embodiments of the present disclosure address the foregoing needs. For example, some embodiments present to the cardholder a visual display, e.g., in a tabulated format such as a matrix or list, of different merchants offering a product desired by the cardholder as well as the estimated rewards that will accrue to the cardholder as a result of transacting for that product with those merchants using one or more rewards cards in the cardholder's existing card portfolio. In some embodiments, a card is suggested to the user, e.g., based on a predetermined criterion that may be optimized (e.g., maximized) to determine which is the best card for a particular buying scenario. Thus, the cardholder is enabled to decide which of her existing cards to use, and from which merchant to buy, based on the estimated rewards presented for each merchant.

In various embodiments, a cardholder owns one or more payment cards that may include, but is not limited to, for example, credit cards, debit cards, stored value cards, or other payment devices associated with payment accounts. Cardholder 110 may also be referred to as a consumer, purchaser, or user, and may be a person or other entity (e.g., company). A card, payment card or loyalty card may be embodied in various tangible forms, including, for example, as a magnetic stripe card, a radio frequency identification (“RFID”) card or other “contactless” card, smart card, or the like. Further, embodiments may also be used in conjunction with virtual cards (e.g., where no physical card is used for a transaction, such as in a digital wallet), or other payment devices (such as, for example, contactless key fobs, payment-enabled mobile devices or telephones, or the like). One or more of the payment card(s) of cardholder 110 may be rewards card(s) 105 that yield rewards (e.g., points, miles, cash back or a discount to be redeemable for the present transaction or future transaction(s), or any other type of reward or incentive) to the cardholder based on transactions made with the rewards card(s).

Initially, cardholder 110 undergoes an enrollment stage to sign up her rewards cards into a profile that may be stored at a database. The profile may be represented and stored in any suitable data format. The enrollment may occur online, e.g., with the cardholder entering pertinent information (e.g., card number and/or expiration date) regarding each of her rewards cards at a web portal or software application that is connected to a network, such as the Internet. Alternatively, various offline forms of enrollment may occur, e.g., with the cardholder providing her rewards card data via mail, telephone, or another communication medium. In some embodiments, the cardholder provides card data regarding all of her payment cards regardless of whether such cards are rewards cards or cards that do not yield rewards, and a subset of those cards comprising rewards cards are automatically identified. For example, a database of all the rewards cards available from various card issuers may be maintained, and card data entered by the cardholder 110 during enrollment may be matched against relevant data in the database to prepare and/or confirm a profile for the cardholder that corresponds to the cardholder's portfolio of rewards cards.

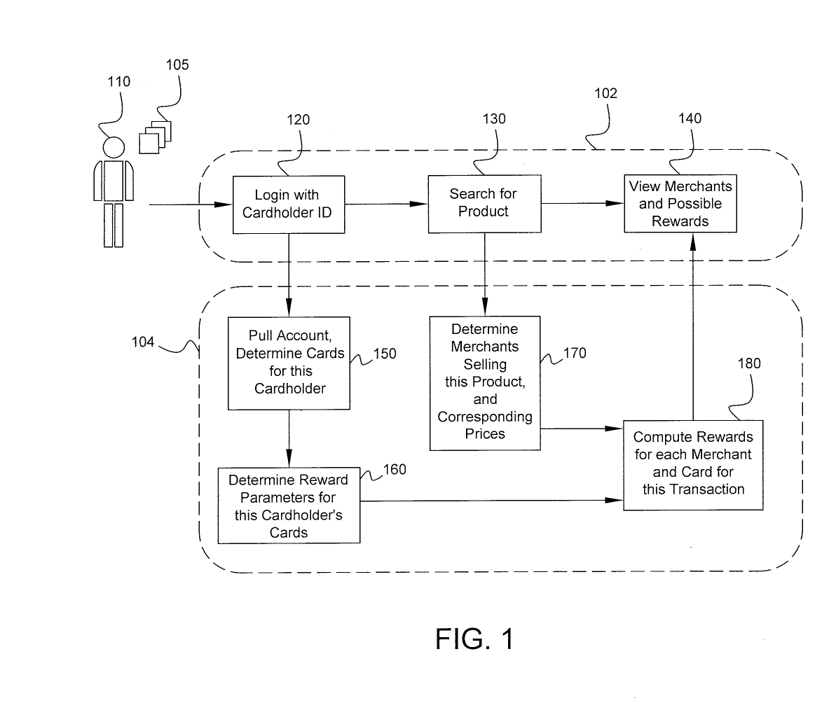

FIG. 1 is a flow diagram of a process in accordance with some embodiments of the present disclosure. FIG. 1 shows various processing including front end processing 102 visible to a cardholder 110 and back end processing 104. At block 120, cardholder 110 logs in (e.g., at a web portal, or a software application connected to the Internet), e.g., by providing a cardholder identifier (ID) and a password.

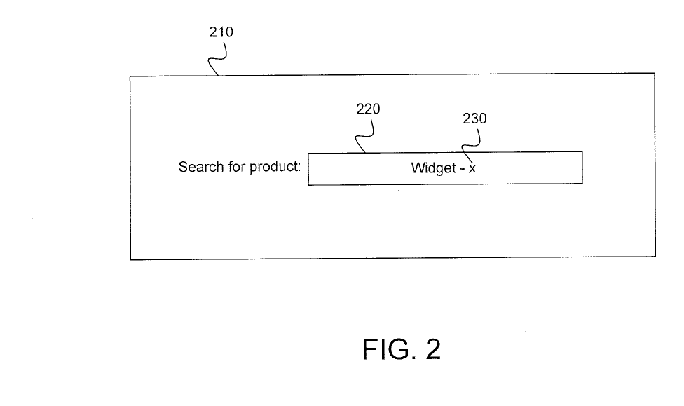

Once the login information is validated, cardholder 110 is presented with an interface (e.g., a graphical or text based interface) that enables her to search (query) for a product (block 130). The product that cardholder 110 searches for may be any type of product, such as any good(s) or service(s). For example, cardholder 110 may enter a product name, SKU code (stock keeping unit code), or other descriptor into a text-based query. FIG. 2 shows one such example input format, with the cardholder entering a product name 230 (in this example, “widget-x”) at a text input field 220 of a screen 210. Alternatively, cardholder 110 may activate (e.g., click or tap) various elements in a graphical user interface (GUI) to select a product. Optionally, a combination of text-based queries and GUI functionality may be used to enable cardholder 110 to select a product.

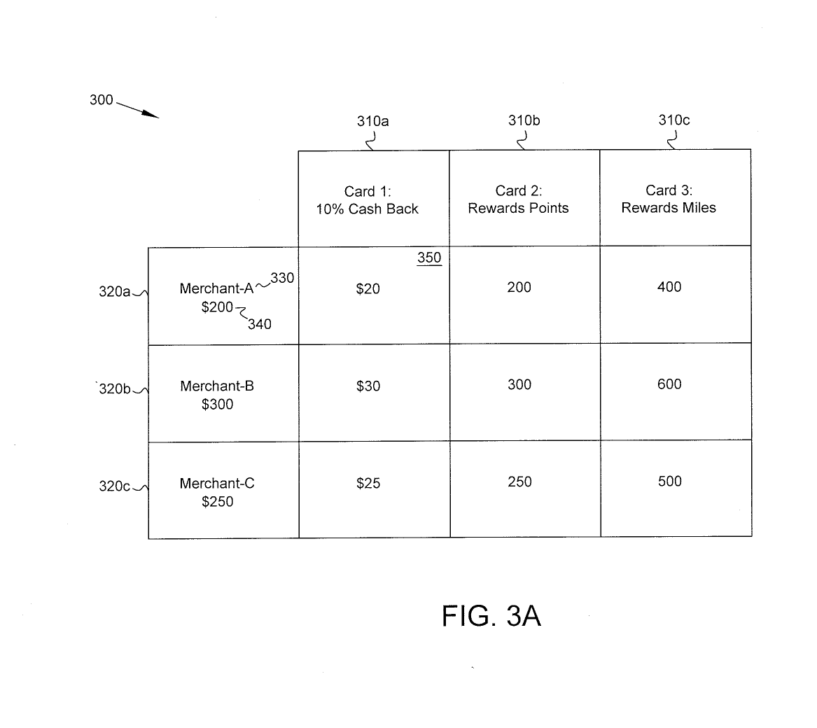

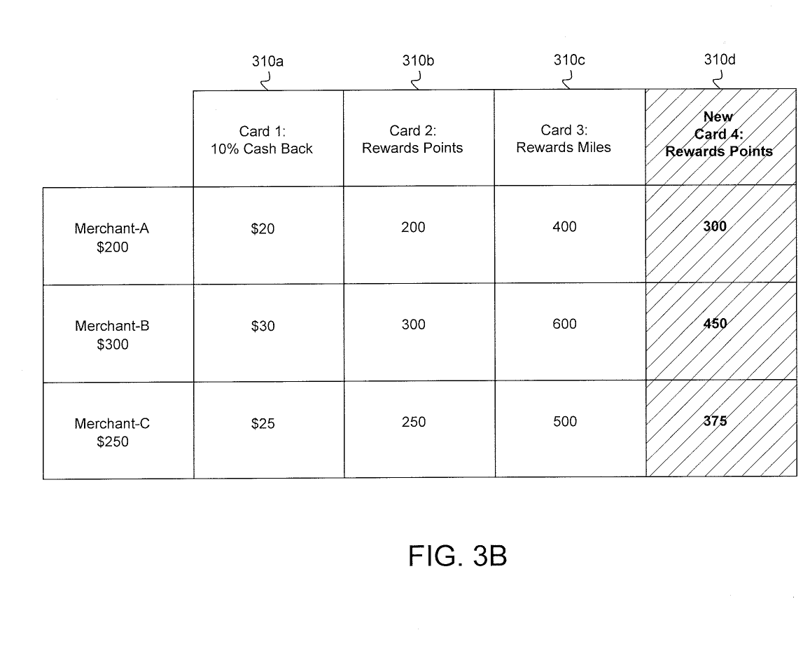

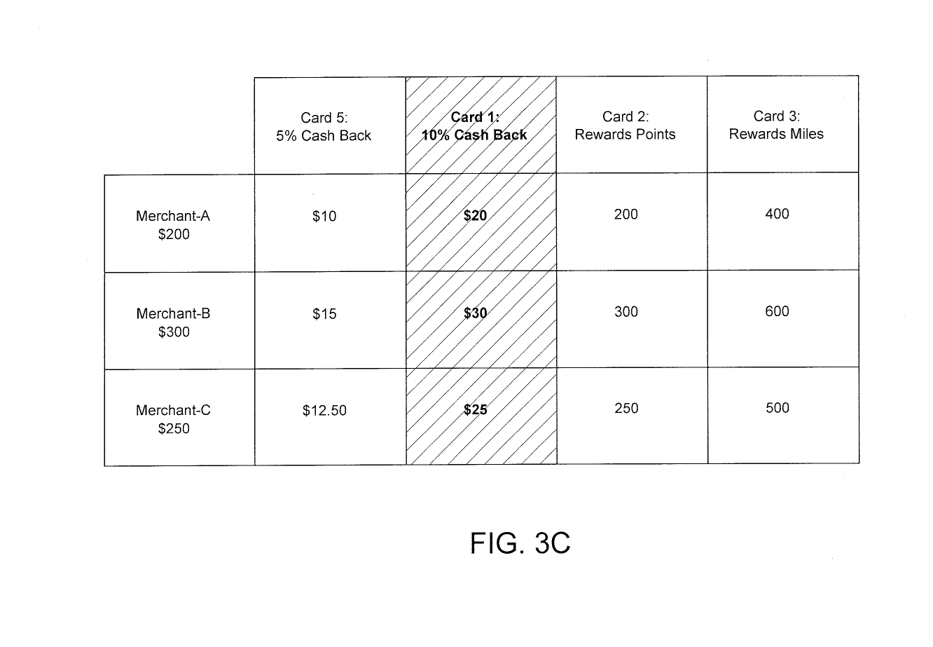

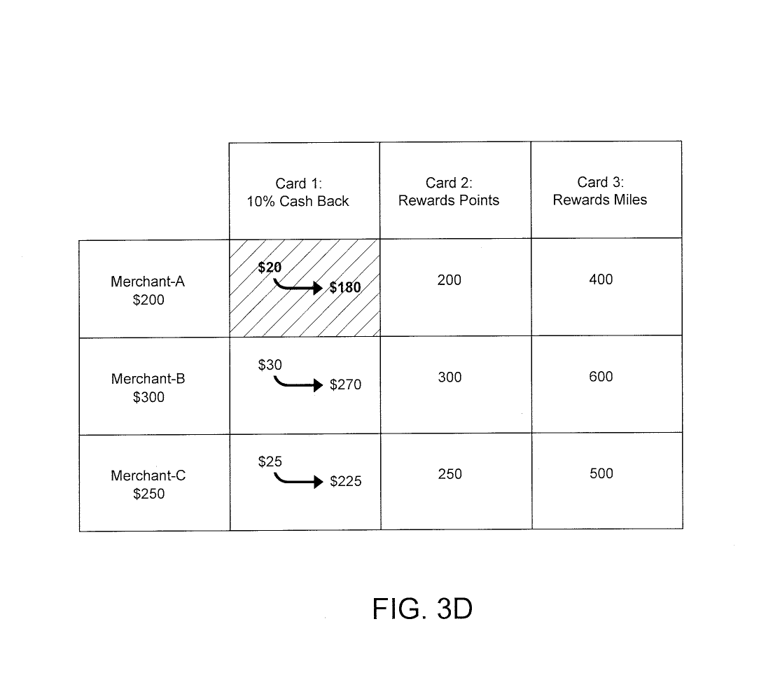

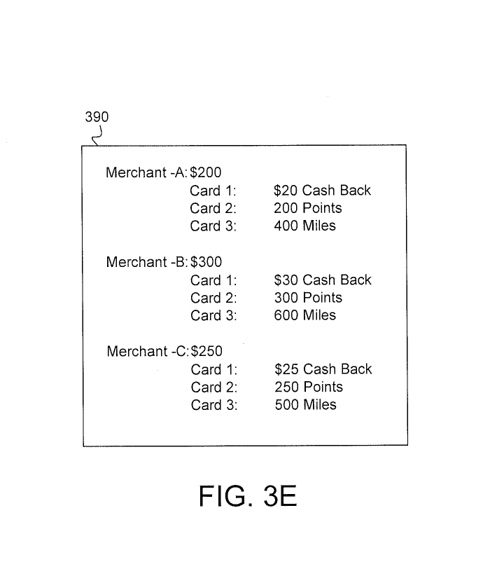

At block 140, information is presented to cardholder 110 regarding one or more merchants offering the product and the rewards that the cardholder would earn if she were to buy the product from any of those merchants using one of her rewards cards. This information may be displayed to cardholder 110 in any convenient format, such as any of the matrix formats shown in FIGS. 3A-3D. Based on this presentation of information, cardholder 110 can then choose which card she desires to use for the transaction, and she can also select a merchant for the transaction. The presentation of merchant information as well as rewards information for various rewards cards in a convenient at-a-glance display enables cardholder 110 to efficiently use various ones of her cards in different respective purchasing scenarios.

Back end processing tasks 104 for supporting the presentation of rewards information are also shown in FIG. 1. Based on a cardholder identifier inputted by the cardholder 110, an account or profile of the cardholder may be retrieved, to determine the cardholder's rewards cards (block 150). For example, a profile corresponding to cardholder 110 may be stored at a database based on the enrollment described above, and this profile specifies each of the cardholder's rewards cards.

Rewards parameters for each of the cardholder's rewards cards are determined (block 160). For example, rewards parameters associated with various rewards cards may be stored in a database (which may the same database that stores the profile specifying the cardholder's various cards, or a different database) and retrieved using various known database techniques. The rewards cards for which rewards parameters are stored may include rewards cards issued by different respective issuers. For example, rewards parameters for a first type of rewards card product available from a first card issuer, and rewards parameters for a second rewards card product available from a second card issuer, may be stored. Cardholders can have any number of cards, each of which is an instance of a particular card product available from an issuer. Any number of card issuers' rewards parameters, and any number of card products, may be maintained in this manner. Advantageously, storing rewards parameters corresponding to rewards cards of different issuers allows rewards information to be displayed to a cardholder regarding cards from those different issuers.

At block 170, a set of one or more merchants selling (or otherwise offering) the product specified by the cardholder is determined, and respective prices at which the one or more merchants are selling the product are also determined. Although examples of sales transactions are described herein for convenience, embodiments of the present disclosure are also applicable to other types of transactions (e.g., rental or lease transactions) for which a card may be presented as payment. The set of merchants selling the product may be determined by performing a search online (e.g., searching the Web or one more websites on the Internet) or by searching a database containing information regarding various products and merchants. In some embodiments, various websites of respective merchants, or websites that aggregate electronic commerce (e-commerce) product and pricing information associated with various merchants, are crawled and data is automatically scraped from them to populate the database containing product/merchant information.

At block 180, rewards that would accrue to the cardholder for each hypothetical merchant-card pair are computed. The computed possible rewards are displayed in any of various formats at block 140.

FIGS. 3A-3D are depictions of example screens displaying information regarding merchants and rewards cards to a cardholder in accordance with some embodiments. Referring to FIG. 3A, suppose cardholder 110 specified a product (e.g., “widget-x” as in FIG. 2) that is available from three merchants (denoted MERCHANT-A, MERCHANT-B, and MERCHANT-C in FIG. 3A). Information regarding these merchants may be displayed in rows (or columns) 320a, 320b, 320c of a matrix (table), and information regarding various rewards cards of the cardholder may be presented in columns (or rows) of the matrix. A rewards amount for each merchant-card pair may be displayed at respective cells 350 of the matrix. Thus, each cell corresponds to one of the merchants and to one of the rewards cards.

In FIG. 3A, a merchant name 330 (such as MERCHANT-A) is displayed in row 320a at 330, and the price at which that merchant is offering the desired product is displayed at 340. Similar information is provided for the merchants shown at rows 320b and 320c. In some embodiments, the rows corresponding to respective merchants are ordered according to a predetermined order, e.g., lowest to highest price (or vice versa). Information regarding the cardholder's rewards cards is shown at columns 310a, 310b, 310c of the matrix. Any number of rows and columns can be used. FIG. 3A shows an example in which cardholder 110 has a first card that yields 10% cash back for each transaction (i.e., returns 10% of the dollar value of the transaction), a second card that yields rewards points (e.g., one point earned per dollar spent in the transaction), and a third card that yields rewards miles (e.g., two miles earned per dollar spent). Various types of information regarding these cards can be presented. For example, in some embodiments the card number for each card is displayed. One or more reward parameters associated with the card (e.g., 10% cash back, or two miles per dollar) may be displayed. In some embodiments, the row corresponding to the merchant with the lowest offer price for the product may be highlighted or otherwise emphasized with a visual indication. Cardholder 110 can quickly scan the contents of the displayed matrix 300 and determine all the information that is relevant to her purchasing decision. Thus, cardholder 110 can efficiently take advantage of her rewards programs.

In some embodiments, a merchant category code (MCC) corresponding for at least one of the merchants is determined. At least one of the reward parameters associated with at least one of the cardholder's rewards cards may be dependent on the merchant category code. Displaying rewards information to the cardholder, e.g., in a matrix format, may include displaying rewards information (e.g., an amount of potential rewards for each possible merchant-card pair) that is dependent on the identity of the potential merchant or on the category of the merchant (e.g., drug store or pharmacy).

Referring to FIG. 3B, in some embodiments, information is also presented to the cardholder regarding one or more rewards cards that she does not currently possess. Such a presentation of information is useful as a marketing tool, as it enables the cardholder to immediately discern benefits that would be available to her if she were to apply for a new card. For example, FIG. 3B shows an example in which information regarding a rewards card offering 1.5 points per dollar spent is displayed at column 310d of the matrix. In this example, the information for the new rewards card that the cardholder 110 does not currently own is shown with a visual indication (here, diagonal striping). Although diagonal striping is shown in FIG. 3B and other figures, it is understood that any type of visual indication may be used.

The new rewards card that is selected to be displayed may be selected on the basis of superior rewards relative to one or more of the cardholder's existing rewards cards. For example, the new rewards card offering 1.5 points per dollar spent may be automatically selected because it offers better (more) rewards than the cardholder's existing rewards cards (e.g., existing points cards). In some embodiments, new rewards cards that the cardholder 110 does not currently own may be displayed for respective rewards categories (e.g., cash back, points, miles). In other embodiments, the user 110 may select one of the rewards categories (e.g., points) as a default or preferred rewards category, and a new card from that category may be automatically selected and displayed.

Although the information regarding the new rewards card is displayed at the right-most column in FIG. 3B, any column of the matrix (or row, if card information is shown along rows) may be used for this purpose. For example, in some embodiments rewards cards of a single category are displayed adjacent to one another (e.g., in contiguous columns), and a new rewards card that the user does not possess may be displayed in a column adjacent to the columns at which the cardholder's existing rewards cards of the same rewards category are displayed. By displaying a new card that yields 1.5 points per dollar next to the cardholder's existing card that yields 1 point per dollar, the marketing potential of such a presentation of information may be enhanced.

In other embodiments, information regarding one or more rewards cards that the cardholder 110 does not currently own may be displayed in a format other than as a row or column of a matrix. For example, a new window, or a pop-up window or frame, may be used to display this information.

Referring to FIG. 3C, in some embodiments, one of the columns (or rows) corresponding to a particular rewards card may be emphasized with a visual indication (such as diagonal striping, shading, etc.). The rewards card that is emphasized in this manner may be a rewards card that is suggested to the cardholder 110 for usage in the present transaction. For example, FIG. 3C shows an example in which the cardholder 110 presently has two cash rewards cards, with CARD-1 yielding 5% cash back and CARD-5 yielding 10% cash back. The cardholder 110 may specify a preference for cash rewards. The cardholder's existing card portfolio may be automatically analyzed to determine which card corresponding to that preference (e.g., cash rewards) yields a maximal amount of rewards. In this example, the card with maximal cash rewards is CARD-1, and that information is conveniently presented to the cardholder.

Although CARD-1 that yields 10% cash back is shown in FIG. 3C to the right of CARD-5 that yields 5% cash back, in other embodiments cards within a given rewards category may be ordered according to a different predetermined ordering (e.g., from most rewards on the left, to least rewards on the right).

Referring to FIG. 3D, in some embodiments the cash back rewards amount for a particular card and merchant may be used to determine and display an effective amount, which is the price at which the merchant offers the product minus the cash back amount. The cell corresponding to the merchant-card pair yielding the lowest effective amount may be emphasized with a visual indication (e.g., diagonal striping in FIG. 3D).

Although a matrix format is shown for displaying information in FIGS. 3A-3D, other formats may be used as well. For example, information related to using each of the cardholder's existing rewards cards for a transaction with a first merchant, then each existing rewards card for a transaction with a second merchant, etc., may be displayed in a non-matrix format, such as a list or outline format 390 shown in FIG. 3E.

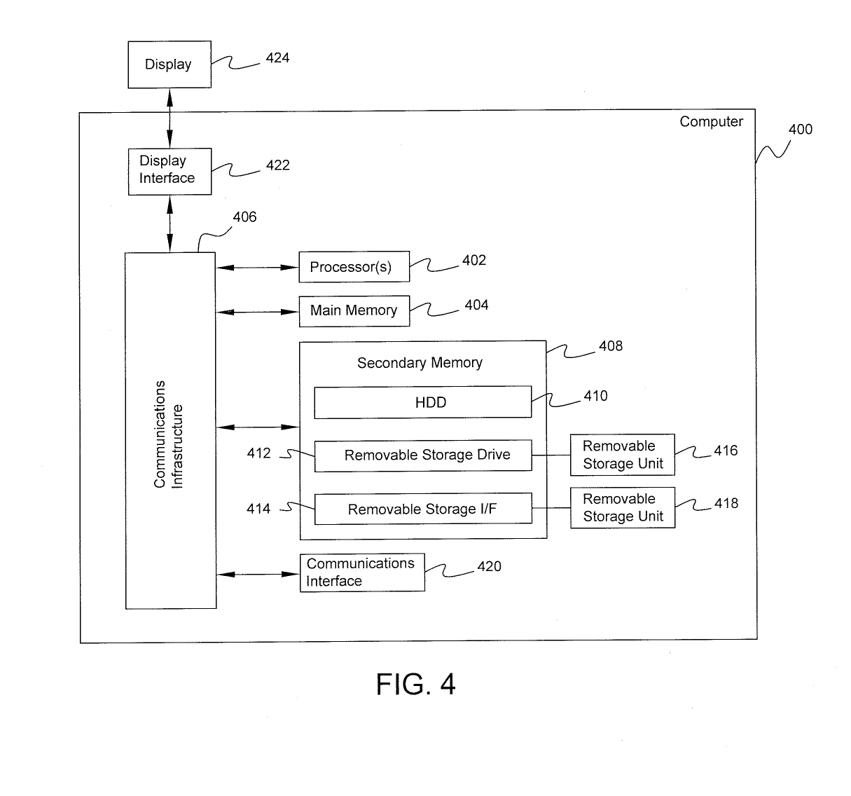

FIG. 4 is an architecture diagram of a computer 400 that may be used in some embodiments. Computer system 400 may include one or more processors 402. Each processor 402 is connected to a communication infrastructure 406 (e.g., a communications bus, cross-over bar, or network). Computer system 400 may include a display interface 422 that forwards graphics, text, and other data from the communication infrastructure 406 (or from a frame buffer, not shown) for display on the display unit 424.

Computer system 400 may also include a main memory 404, such as a random access memory (RAM), and a secondary memory 408. The secondary memory 408 may include, for example, a hard disk drive (HDD) 410 and/or removable storage drive 412, which may represent a floppy disk drive, a magnetic tape drive, an optical disk drive, a memory stick, or the like as is known in the art. The removable storage drive 412 reads from and/or writes to a removable storage unit 416. Removable storage unit 416 may be a floppy disk, magnetic tape, optical disk, or the like. As will be understood, the removable storage unit 416 may include a computer readable storage medium having tangibly stored therein (embodied thereon) data and/or computer software instructions, e.g., for causing the processor(s) to perform various operations.

In alternative embodiments, secondary memory 408 may include other similar devices for allowing computer programs or other instructions to be loaded into computer system 400. Secondary memory 408 may include a removable storage unit 418 and a corresponding removable storage interface 414, which may be similar to removable storage drive 412, with its own removable storage unit 416. Examples of such removable storage units include, but are not limited to, USB or flash drives, which allow software and data to be transferred from the removable storage unit 416, 418 to computer system 400.

Computer system 400 may also include a communications interface 420. Communications interface 420 allows software and data to be transferred between computer system 400 and external devices. Examples of communications interface 420 may include a modem, Ethernet card, wireless network card, a Personal Computer Memory Card International Association (PCMCIA) slot and card, or the like. Software and data transferred via communications interface 420 may be in the form of signals, which may be electronic, electromagnetic, optical, or the like that are capable of being received by communications interface 420. These signals may be provided to communications interface 420 via a communications path (e.g., channel), which may be implemented using wire, cable, fiber optics, a telephone line, a cellular link, a radio frequency (RF) link and other communication channels.

In this document, the terms “computer program medium” and “non-transitory computer-readable storage medium” refer to media such as, but not limited to, media at removable storage drive 412, or a hard disk installed in hard disk drive 410, or removable storage unit 416. These computer program products provide software to computer system 400. Computer programs (also referred to as computer control logic) may be stored in main memory 404 and/or secondary memory 408. Computer programs may also be received via communications interface 420. Such computer programs, when executed by a processor, enable the computer system 400 to perform the features of the methods discussed herein. For example, main memory 404, secondary memory 408, or removable storage units 416 or 418 may be encoded with computer program code (instructions) for performing operations corresponding to various processes disclosed herein.

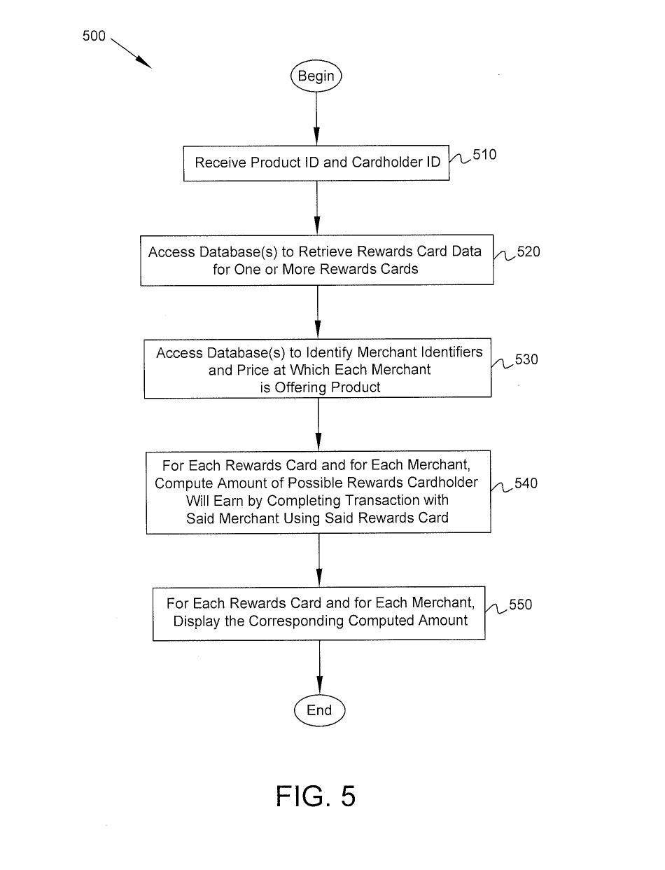

FIG. 5 is a flow diagram of a process in accordance with some embodiments. After process 500 begins, a product identifier and a cardholder identifier are received (block 510). The product identifier and the cardholder identifier correspond to (specify or identify) a product and a cardholder, respectively. At least one computer database is accessed (block 520) to retrieve, based on the cardholder identifier, data pertaining to one or more rewards cards owned by the cardholder. One or more reward parameters are associated with each rewards card. The computer database(s) is accessed (block 530) to identify, based on the product identifier, merchant identifiers corresponding to merchants offering the product and the price at which each of those merchants is offering the product. At one or more computer processors, for each rewards card and for each merchant, a first amount of rewards is computed (block 540), which is an amount of rewards that the cardholder will earn (i.e., could possibly earn) if the cardholder completes a transaction for the product with said merchant using said rewards card, wherein the rewards amount is computed based on at least the reward parameters associated with said rewards card and the offer price corresponding to said merchant. Process 500 includes displaying (block 550) to the cardholder the first rewards amount corresponding to each rewards card and to each merchant. For example, the respective first rewards amounts corresponding to various merchant-card combinations can be displayed in a matrix format, with merchants listed along rows and cards listed along columns (or vice versa), or in any other convenient format. Any of blocks 510, 520, 530, 540, and 550 can be performed by the one or more computer processors.

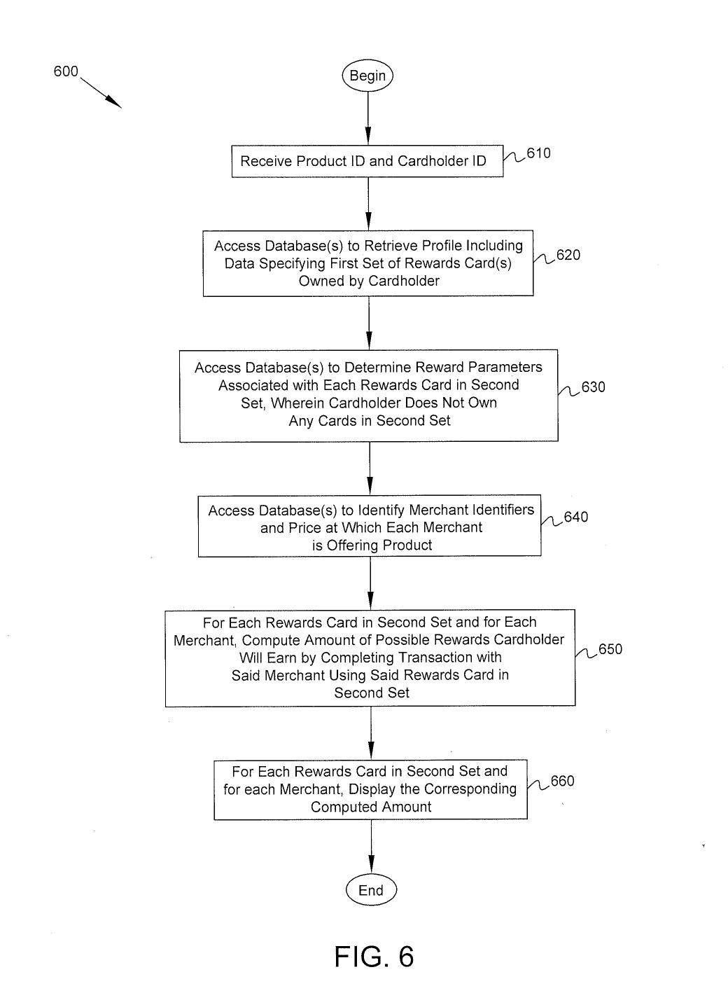

FIG. 6 is a flow diagram of a process in accordance with some embodiments. After process 600 begins, a product identifier and a cardholder identifier are received (block 610). The product identifier and the cardholder identifier correspond to (specify or identify) a product and a cardholder, respectively. At least one computer database is accessed (block 620) to retrieve, based on the cardholder identifier, a profile including data specifying a first set of one or more rewards cards owned by the cardholder. One or more reward parameters are associated with each rewards card in the first set. The computer database(s) is accessed (block 630) to determine, based on the retrieved profile, reward parameters associated with each rewards card in a second set of one or more rewards cards. The cardholder does not own any of the cards in the second set. The computer database is accessed (block 640) to identify, based on the product identifier, a plurality of merchant identifiers corresponding to merchants offering the product and the price at which each of those merchants is offering the product. At one or more computer processors, for each rewards card in the second set and for each merchant, an amount of rewards is computed (block 650), which is an amount of rewards that the cardholder will earn (i.e., could possibly earn) if the cardholder completes a transaction for the product with said merchant using said rewards card in the second set, wherein the rewards amount is computed based on at least the reward parameters associated with said rewards card in the second set and the offer price corresponding to said merchant. Process 600 includes displaying (block 660) to the cardholder the rewards amount corresponding to each rewards card in the second set and to each merchant. For example, the respective rewards amounts corresponding to various merchant-card combinations can be displayed in a matrix format, with merchants listed along rows and cards listed along columns (or vice versa), or in any other convenient format. Any of blocks 610, 620, 630, 640, 650, and 660 can be performed by the one or more computer processors.

It is understood by those familiar with the art that the system described herein may be implemented in hardware, firmware, or software encoded on a non-transitory computer-readable storage medium.

The systems and processes are not limited to the specific embodiments described herein. In addition, components of each system and each process can be practiced independent and separate from other components and processes described herein.

The previous description of the embodiments is provided to enable any person skilled in the art to practice the disclosure. The various modifications to these embodiments will be readily apparent to those skilled in the art, and the generic principles defined herein may be applied to other embodiments without the use of inventive faculty. Thus, the present disclosure is not intended to be limited to the embodiments shown herein, but is to be accorded the widest scope consistent with the principles and novel features disclosed herein.

What is claimed is:

1. A method comprising:
receiving an product identifier and a cardholder identifier corresponding to a product and a cardholder, respectively;
accessing at least one computer database to retrieve, based on the cardholder identifier, data pertaining to one or more rewards cards owned by the cardholder, one or more reward parameters being associated with each rewards card;
accessing the at least one computer database to identify, based on the product identifier, a plurality of merchant identifiers corresponding to merchants offering the product and the price at which each merchant is offering the product;
at one or more computer processors, computing, for each rewards card and for each merchant, a first amount of rewards that the cardholder will earn if the cardholder completes a transaction for the product with said merchant using said rewards card, wherein the rewards amount is computed based on at least the reward parameters associated with said rewards card and the offer price corresponding to said merchant; and
displaying to the cardholder the first rewards amount corresponding to each rewards card and to each merchant.

2. The method of claim 1, wherein data pertaining to at least two rewards cards, issued by different issuers, are retrieved from the at least one computer database.

3. The method of claim 1, wherein the displaying includes displaying the rewards amounts in respective cells of a matrix, the cells being arranged in rows and columns.

4. The method of claim 3, further comprising:
receiving an input from the cardholder selecting one of the cells; and
processing a transaction for the product using the rewards card corresponding to the selected cell, wherein the transaction is between the cardholder and the merchant corresponding to the selected cell.

5. The method of claim 1, further comprising:
displaying an indication that one of the rewards cards is a suggested rewards card for the cardholder to use.

6. The method of claim 5, further comprising:
identifying one of the rewards cards as providing a maximal amount of rewards within a rewards category;
wherein the suggested rewards card is said one identified rewards card.

7. The method of claim 6, wherein said rewards category is one of a plurality of rewards categories, the method further comprising:
receiving an input from the cardholder specifying said rewards category as a default rewards category among the plurality of rewards categories.

8. The method of claim 1, further comprising:
at the one or more computer processors, computing, for each merchant, a second amount of rewards that the cardholder will earn if the cardholder completes the transaction for the product with said merchant using a rewards card not owned by the cardholder; and
displaying to the cardholder the second amount of rewards corresponding to each merchant.

9. The method of claim 8, further comprising:
receiving an input from the cardholder designating the rewards card not owned by the cardholder; and
displaying to the cardholder a screen that enables the cardholder to sign up for the rewards card not owned by the cardholder.

10. The method of claim 1, wherein at least one rewards card has a cash back rewards policy, the method further comprising:
displaying to the cardholder an effective discounted price for the product offered by at least one of the merchants, wherein the effective discounted price is based on the price at which said at least one merchant is offering the product and the cash back rewards policy.

11. The method of claim 1, further comprising determining a merchant category code corresponding to the merchant identifier of at least one of the merchants, wherein at least one of the reward parameters associated with at least one of the rewards cards is dependent on the merchant category code.

12. A method comprising:
receiving an product identifier and a cardholder identifier corresponding to a product and a cardholder, respectively;
accessing at least one computer database to retrieve, based on the cardholder identifier, a profile including data specifying a first set of one or more rewards cards owned by the cardholder, one or more reward parameters being associated with each rewards card in the first set;
accessing the at least one computer database to determine, based on the retrieved profile, reward parameters associated with each rewards card in a second set of one or more rewards cards, wherein the cardholder does not own any of the cards in the second set;
accessing the at least one computer database to identify, based on the product identifier, a plurality of merchant identifiers corresponding to merchants offering the product and the price at which each merchant is offering the product;
at one or more computer processors, computing, for each rewards card in the second set and for each merchant, an amount of rewards that the cardholder will earn if the cardholder completes a transaction for the product with said merchant using said rewards card in the second set, wherein the rewards amount is computed based on at least the reward parameters associated with said rewards card in the second set and the offer price corresponding to said merchant; and
displaying to the cardholder the rewards amount corresponding to each rewards card in the second set and to each merchant.

13. The method of claim 12, further comprising:
retrieving, from the at least one computer database, reward parameters associated with each rewards card in the first set;
at the one or more computer processors, computing, for each rewards card in the first set and for each merchant, an amount of rewards that the cardholder will earn if the cardholder completes the transaction for the product with said merchant using said rewards card in the first set, wherein the rewards amount corresponding to each rewards card in the first set and to each merchant is computed based on at least the retrieved reward parameters associated with each rewards card in the first set; and
displaying to the cardholder the rewards amount corresponding to each rewards card in the first set and to each merchant.

14. The method of claim 13, wherein the rewards amount corresponding to each rewards card in the first and second sets and to each merchant are displayed in cells of a matrix.

15. A system comprising:
one or more computer databases having stored therein:
first data including one or more reward parameters associated with each rewards card in a plurality of rewards cards; and
a plurality of profiles associated with respective ones of a plurality of cardholders, the profile associated with each cardholder including second data specifying one or more of the rewards cards owned by said cardholder;
one or more computer processors operably coupled to access the one or more computer databases; and
a non-transitory computer-readable storage medium having instructions stored tangibly thereon, the instructions when executed by the one or more computer processors causing the one or more computer processors to:
receive a product identifier and a cardholder identifier corresponding to one of the products and one of the cardholders, respectively;
access the one or more computer databases to retrieve, based on the received cardholder identifier, the profile associated with said one cardholder;
identify, based on the received product identifier, a plurality of merchant identifiers corresponding to respective ones of a plurality of merchants offering said one product and the price at which each merchant is offering said one product;
compute, for each rewards card associated with the retrieved profile and for each merchant, a first amount of rewards that the cardholder will earn if the cardholder completes a transaction for the product with said merchant using said rewards card, wherein the first rewards amount is computed based on at least the reward parameters associated with said rewards card and the offer price corresponding to said merchant; and
display the first rewards amount corresponding to each rewards card and to each merchant.

16. The system of claim 15, wherein the instructions when executed by the one or more computer processors cause the one or more computer processors to retrieve, from the at least one computer database, data pertaining to at least two rewards cards issued by different issuers.

17. The system of claim 15, wherein the instructions when executed by the one or more computer processors further cause the one or more computer processors to:
display an indication that one of the rewards cards associated with the retrieved profile is a suggested rewards card for said one cardholder to use.

18. The system of claim 15, wherein the instructions when executed by the one or more computer processors further cause the one or more computer processors to:
compute, for each merchant, a second amount of rewards that said one cardholder will earn if said one cardholder completes the transaction for the product with said merchant using a rewards card not owned by said one cardholder; and
display the second amount of rewards corresponding to each merchant.

19. A system comprising:
one or more computer databases having stored therein:
first data including one or more reward parameters associated with each rewards card in a plurality of rewards cards; and
a plurality of profiles associated with respective ones of a plurality of cardholders, the profile associated with each cardholder including second data specifying a first set of one or more of the rewards cards owned by said cardholder;
one or more computer processors operably coupled to access the one or more computer databases; and
a non-transitory computer-readable storage medium having instructions stored tangibly thereon, the instructions when executed by the one or more computer processors causing the one or more computer processors to:
receive a product identifier and a cardholder identifier corresponding to one of the products and one of the cardholders, respectively;
access the one or more computer databases to retrieve, based on the received cardholder identifier, the profile associated with said one cardholder;
access the one or more computer databases to determine, based on the retrieved profile, the reward parameters associated with each rewards card in a second set of one or more of the rewards cards, wherein the cardholder does not own any of the cards in the second set;
identify, based on the received product identifier, a plurality of merchant identifiers corresponding to respective ones of a plurality of merchants offering said one product and the price at which each merchant is offering said one product;
compute, for each rewards card in the second set and for each merchant, an amount of rewards that the cardholder will earn if the cardholder completes a transaction for the product with said merchant using said rewards card in the second set, wherein the rewards amount is computed based on at least the reward parameters associated with said rewards card in the second set and the offer price corresponding to said merchant; and
display the rewards amount corresponding to each rewards card in the second set and to each merchant.

20. The system of claim 19, wherein the instructions when executed by the one or more computer processors further cause the one or more computer processors to:
retrieve, from the one or more computer databases, reward parameters associated with each rewards card in the first set;
compute, for each rewards card in the first set and for each merchant, an amount of rewards that the cardholder will earn if the cardholder completes the transaction for the product with said merchant using said rewards card in the first set, wherein the rewards amount corresponding to each rewards card in the first set and to each merchant is computed based on at least the retrieved reward parameters associated with each rewards card in the first set; and
display the rewards amount corresponding to each rewards card in the first set and to each merchant.
